(19) United States
(12) Patent Application Publication
(10) Pub. No.: US 2026/0132870 A1
(43) Pub. Date: May 14, 2026

(54) Flexible Pipe and a Method of Manufacturing a Flexible Pipe

(71) Applicant: Polyflow LLC, Midland, TX (US)

(72) Inventors: Timothy Lee Cureton, Arvada, CO (US); Liang Yu, Katy, TX (US); Matthew Leonard Ryan, The Woodlands, TX (US); Roberto Carlos BARRIENTOS, Houston, TX (US)

(73) Assignee: Polyflow LLC, Midland, TX (US)

(21) Appl. No.: 18/941,762

(22) Filed: Nov. 8, 2024

(51) Int. Cl. F16L 11/08; F16L 11/12

(52) U.S. Cl. CPC F16L 11/083; F16L 11/12

(57) ABSTRACT

There is disclosed a flexible pipe comprising a pipe body comprising first and second pipe layers. The first pipe layer is a composite pipe layer formed of a composite comprising a reinforcement embedded in a thermoplastic matrix material. The pipe further comprises an end fitting to which a first end of the pipe body is connected, the end fitting comprising a tubular connector member concentric to the pipe body. A length of the pipe body at the first end is free of the second pipe layer so exposing the first pipe layer to the tubular connector member to enable direct contact therebetween.

### TECHNICAL FIELD

The invention relates to a flexible pipe for conveying a fluid relating to oil and gas operations, in particular an unbonded reinforced thermoplastic pipe. The invention also relates to a method of manufacturing such a pipe.

### BACKGROUND

Unbonded reinforced thermoplastic pipe (RTP) is a flexible, high-performance pipe typically used in oil and gas applications for transporting fluids, including hydrocarbons, water, and gas. Unlike traditional rigid pipelines, RTP comprises multiple layers, each serving a distinct purpose: an inner layer provides fluid containment; a reinforcement layer surrounds the inner layer and resists mechanical loads, including tensile loads and internal pressure; and an outer layer surrounds the reinforcement layer and protects the pipe from external damage and environmental factors. The term “unbonded” refers to the fact that the layers of the pipe are not adhesively, or otherwise, bonded to one another.

To ensure the safe and reliable operation of an RTP system, sections of pipe are joined using end fittings. An end fitting serves as the transition point between adjacent sections of RTP, as well between a section of pipe and other parts of the pipeline or equipment. The principal parts of an end fitting include a stem and a ferrule, both of which are hollow, tubular components, the stem being disposed concentrically within the ferrule so that an annular gap extends therebetween. The stem extends within the bore of the pipe, radially inward of the liner. The stem supports the liner and acts as a conduit for fluids transported through the pipe, and may have sealing grooves to accommodate seals, ensuring a fluid-tight connection between the liner and the fitting. The ferrule extends over the outer layer and provides mechanical grip by clamping down on the layers of the pipe, thereby securing the multiple layers within the fitting. More specifically, the ferrule applies a radially inward force on layers of the RTP upon tightening, e.g., swaging or crimping, thereby clamping, or gripping, the layers between the ferrule and the stem, the stem resisting the radial force applied by the ferrule. The clamping prevents the layers from disengaging with the fitting due to internal pressure or axial forces. The clamping force is transmitted through the inner layer and outer layers to the reinforcement layer, since it is the reinforcement layer that provides the pipe body with its mechanical strength.

It is an object of embodiments of the invention to provide an improved flexible pipe and method of making the same, and/or at least mitigate one or more problems associated with known arrangements.

### SUMMARY OF THE INVENTION

According to an aspect of the invention, there is provided a flexible pipe comprising: a pipe body comprising first and second pipe layers, the first pipe layer being a composite pipe layer formed of a composite comprising a reinforcement embedded in a thermoplastic matrix material; and an end fitting to which a first end of the pipe body is connected, the end fitting comprising a tubular connector member concentric to the pipe body, wherein a length of the pipe body at the first end is free of the second pipe layer so exposing the first pipe layer to the tubular connector member to enable direct contact therebetween. This arrangement allows improved transfer of the clamping force, i.e., gripping or compression, between the end fitting and the second pipe layer, which provides the pipe body with mechanical strength. The arrangement may improve the integrity, including the sealing integrity, and/or the load-bearing capabilities of the flexible pipe.

In certain embodiments, the first pipe layer may be disposed radially inward of the second pipe layer and the tubular connector member is disposed radially outward of the first pipe layer. Additionally, or alternatively, the first pipe layer may be formed of one or more helically wrapped tapes formed of the composite, and the reinforcement may comprise a plurality of metallic wires. The second pipe layer may be a polymeric pipe layer providing a protective layer.

In certain embodiments, the end fitting may comprise a further tubular connector member disposed radially inward of the first pipe layer.

In certain embodiments, the pipe body comprises a third pipe layer disposed radially inward of the first pipe layer. The third pipe layer may be a polymeric pipe layer providing an impervious liner layer. A further length of the pipe body at the first end may free of the third pipe layer so exposing the first pipe layer to the further tubular connector member to enable direct contact therebetween.

In certain embodiments, the first pipe layer may be clamped between the tubular connector member and the further tubular connector member. The third pipe layer may be clamped, together with the first pipe layer, between the tubular connector member and the further tubular connector member. The pipe may be a reinforced thermoplastic pipe for conveying oil and gas field fluids.

According to an aspect of the invention, there is provided a method of manufacturing a flexible pipe, the method comprising: providing a pipe body comprising first and second pipe layers, the first pipe layer being a composite pipe layer formed of a composite comprising a reinforcement embedded in a thermoplastic matrix material; providing an end fitting comprising a tubular connector member; removing a length of the second pipe layer at a first end of the pipe body to provide a length of the pipe body free of the second pipe layer; and introducing the pipe body into the tubular connector member, or visa versa, so bringing the first pipe layer and the tubular connector member into direct contact with one another.

In certain embodiments, the first pipe layer may be disposed radially inward of the second pipe layer, and the method may comprise introducing the pipe body into the tubular connector member, i.e., placing the tubular connector member over the first end of the pipe body. The end fitting may comprise a further tubular connector member disposed radially inward of the tubular connector member and an annular gap extending therebetween, and the method may comprise introducing the pipe body into the annular gap.

In certain embodiments, the pipe body may comprise a third pipe layer disposed radially inward of first pipe layer, and the method may comprises removing a length of the third pipe layer at the first end of the pipe body to provide a further length of the pipe body free of the third pipe layer, and introducing the pipe body into annular gap so bringing the third pipe layer and the further tubular connector member into direct contact with one another.

In certain embodiments, the method may comprise clamping the first end of the pipe body in the annular gap. Clamping the first end of the pipe body may comprise clamping the first pipe layer only, i.e., not clamping the first and/or third pipe layers. Additionally, or alternatively, clamping the first end of the pipe body may comprise crimping or swagging the tubular connector member.

### BRIEF DESCRIPTION OF THE DRAWINGS

Embodiments of the invention will now be described, by way of example only, with reference to the accompanying figures, in which:

FIG. 1 is a perspective view of a flexible pipe according to an embodiment of the invention, including a three-dimensional cutaway section; and

FIG. 2 is a perspective view of a pipe body of the flexible pipe according to the embodiment shown in FIG. 1.

### DETAILED DESCRIPTION OF EMBODIMENTS OF THE INVENTION

Generally, embodiments of the invention have application in oil and gas operations, e.g., for use as an onshore pipe and/or for conveying oil and gas field fluids, such fluids including one or more of gas (e.g., methane, ethane, hydrogen, and CO₂), hydrocarbon fluids (e.g., oil), water, or other fluids (e.g., slurry). Other applications are contemplated, including mining operations, water management, municipal utilities, and chemical processing. Moreover, embodiments of the invention may have particular application as RTP, including unbonded RTP, the properties of which-particularly flexibility, durability, and the ability to handle high pressures-make it an attractive option in various industrial applications. Unlike steel pipes, RTP does not corrode, making it suitable for transporting aggressive chemicals, saline water, and other corrosive substances.

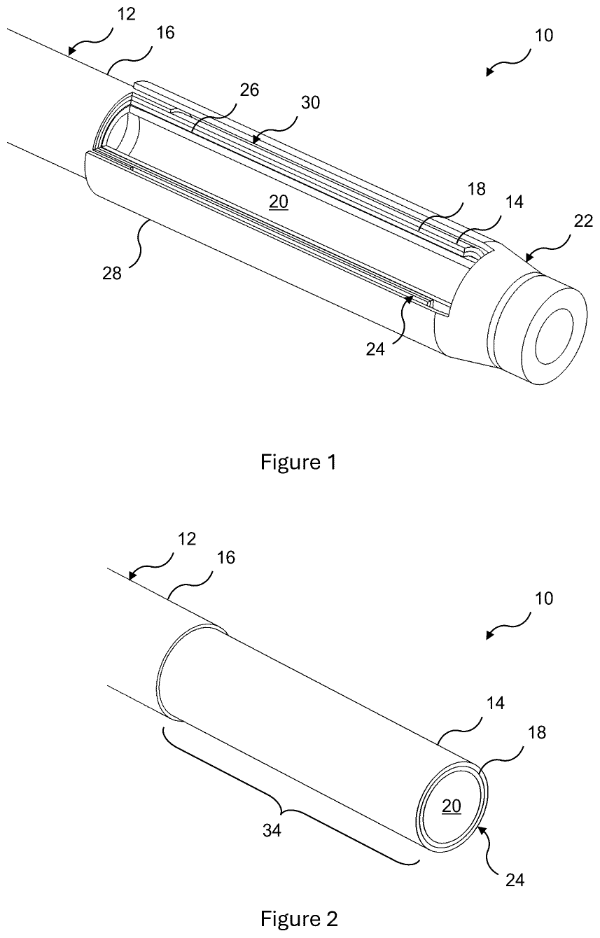

FIG. 1 shows a flexible pipe 10 according to an embodiment of the invention. The pipe 10 comprises a pipe body 12 having a first pipe layer 14, a second pipe layer 16 and a third pipe layer 18. The first pipe layer 14 is disposed intermediate the second and third pipe layers 16, 18. As such, the second pipe layer 16 is radially outward of the first pipe layer 14, and the third pipe layer 18 is radially inward of the first pipe layer 14. As in the illustrated embodiment, the first pipe layer 14 may be in direct contact with the second pipe layer 16 and/or the third pipe layer 18. Alternatively, further pipe layers may be provided intermediate the first pipe layer 14 and the second pipe layer 16 and/or the third pipe layer 18. The pipe body 12 delimits a central bore 20 for conveying a fluid, e.g., a hydrocarbon fluid, along the length of the pipe body 12, and hence through, or along, the pipe 10.

The first pipe layer 14 is a composite pipe layer formed of a composite comprising a reinforcement embedded in a thermoplastic matrix material. The reinforcement may be formed of a plurality of metallic wires, or strands, e.g., steel wires or wires formed of a metal alloy. However, the reinforcement may be provided by any suitable material, including aramid fibre, glass fibre, basalt fibre, and carbon fibre. Suitable materials may exhibit high tensile strength, flexibility, and/or corrosion resistance. The reinforcement, e.g., the wires, may extend continuously through the first pipe layer 14, and/or along the total length thereof. The thermoplastic matrix material may be formed from any suitable thermoplastic polymer or polymer compound. Suitable polymers include polyvinylidene fluoride (PVDF), polyethylene (PE) including grades of raised polyethylene of temperature resistance (PE-RT) and cross-linked polyethylene (PEX), polyphenylene sulphide (PPS), polypropylene (PP), a thermoplastic elastomer, and a polyamide. These thermoplastics are commonly used in the manufacture of RTP.

The first pipe layer 14 provides a structural layer, or reinforcement layer, of the pipe body 12. The reinforcement principally handles mechanical stresses, including internal pressure and tensile loads acting along the length of the pipe 10, while the thermoplastic matrix material principally protects the reinforcement from environmental exposure.

The pipe 10 further comprises an end fitting 22, to which a first end 24 of the pipe body 12 is mounted. A second end (not shown) of the pipe body 12 may be mounted, or mountable, to a similar, or an identical, end fitting. The end fitting 22 comprises a first tubular connector member 26, which in the following description is referred to as a stem, and a second tubular connector member 28, which in the following description is referred to as a ferrule. The stem 26 is disposed radially inward of the first pipe layer 14 (or the pipe body 12), and the ferrule 28 is disposed radially outward thereof, forming an annular gap 30 extending between the stem 26 and the ferrule 28. The gap 30 is for receipt the first end 24 of the pipe body 12, such that the stem 26 and ferrule 28 are concentric to the to the pipe body 12.

The stem 26 serves as an internal support for forming a load carrying connection between the pipe body 12 and the end fitting 22. In certain embodiments, the stem 26 may be configured with grooves or serrations to grip an inner surface of the third pipe layer 18 (or the pipe body 12), helping the stem 26 to stay in place and transfer loads between the pipe body 12 and the end fitting 22. The stem 26 may be provided with sealing features and/or incorporate one or more sealing rings, e.g., O-rings, to facilitate forming a fluid-tight seal between the stem 26 and one or both of the first pipe layer 14 and the third pipe layer 18. The ferrule 28 is configured to apply compression around an outer surface of the pipe body 12, e.g., by swaging or crimping. This compression causes the stem 26 and the ferrule 28 to cooperate with one another to connect the pipe body 12 to the end fitting 22, by clamping, or gripping, the first end 24 of the pipe body 12 in the annular gap 30, thereby securing the pipe body 12 in place and creating a seal that prevents fluid leakage from the pipe 10. In certain embodiments, an internal wedge, or collet system, may be provided to enhance the clamping efficacy between the pipe body 12 and the end fitting 22, and/or one or more seal rings may be provided between the pipe body 12 and the ferrule 28 to ensure sealing therebetween.

In certain embodiments, the first pipe layer 14 may be formed of one or more helically wrapped tapes formed of the reinforcement embedded in the composite. The tapes may extend helically about the bore 20, and/or be wrapped about the third pipe layer 18, or an intermediate further pipe layer. The angle of winding, also referred to as the lay angle, may be critical for balancing axial and hoop strength in a given embodiment. Hoop winding, sometimes referred to as high-angle winding, may be used, in which the one or more tapes are wound at a high angle, e.g., up to close to 90° relative to a central axis of the pipe 10. This type of winding provides hoop strength, which is essential for resisting internal pressure that tries to expand the pipe radially. Axial or low-angle winding may be used, in which winding is at a lower angle, e.g., closer to the axis, and provides axial strength, which helps resist longitudinal forces such as tension, bending, and external loads on the pipe 10. The helically wrapped tapes may be wrapped having a lay angle of at least 30° and/or up to 90°. In certain embodiments, the lay angle may be 55°. At least two of the helically wrapped tapes form respective sub-layers to form the first pipe layer 14.

FIG. 2, which show the pipe 10 with the end fitting 22 absent, best shows a length 32 at the first end 24 of the pipe body 12 free of the second pipe layer 16, thereby exposing the first pipe layer 14. The first pipe layer 14 would otherwise be covered over by, or beneath, the second pipe layer 16. The first pipe layer 14 is therefore exposed to the ferrule 28 when the connection between the pipe body 12 and the end fitting 22 if formed, enabling direct contact between the first pipe layer 14 and the end fitting 22, i.e., the ferrule 28. This direct contact may offer a number of advantages. Since the first pipe layer 14 provides a structural layer of the pipe body 12, loads transferred between the pipe body 12 and the end fitting 22 are principally carried by the first pipe layer 14. By enabling the direct contact, loads need not be otherwise transferred via the second pipe layer 16, which may be less suited to endure operational loads, improving axial load transfer. This may improve long-term reliability of the pipe 10 and/or reduce the risk of slippage or mechanical failure. The first pipe layer 14 is also principally responsible for the pressure containment capabilities of the pipe body 12. Therefore, transmitting the clamping force of the ferrule 28 directly to the first pipe layer 14 may additionally, or alternatively, reduce the risk of leakage.

The length 32 over which the pipe body 12 is free of the second pipe layer 16 may be any suitable length, e.g., at least approximate 1× the diameter of the pipe body 12 and/or up to the length of the end fitting plus 1× the diameter of the pipe body 12. The length 32 may correspond, at least approximately, to a length of the pipe body 12 received within the end fitting 22 when forming the connection therebetween. As shown in the illustrated embodiment, the length 32 may be a terminal length of the pipe body 12. Alternatively, in certain embodiments, the length 32 may be offset from the terminal length of the pipe body 12, the terminal length comprising the second pipe layer 16. The length 32 may be wholly, or continuously, free of the second pipe layer 16, or partially, or discontinuously, free of the second pipe layer 16, i.e., regions of the second pipe layer 16 may be absent of the length 32 to expose regions of the first pipe layer 14 to effect direct contact between the first pipe layer 14 and the end fitting 22.

In certain embodiments, a further length (not shown) at the first end 24 of the pipe body 12 free of the third pipe layer 18, thereby exposing the first pipe layer 14. The first pipe layer 14 would otherwise be covered over by, or beneath, the third pipe layer 18, relative to the bore 20. The first pipe layer 14 may therefore be exposed to the stem 26 when the connection between the pipe body 12 and the end fitting 22 is formed, enabling direct contact between the first pipe layer 14 and the end fitting 12, i.e., the stem 26. This direct contact may be advantages for the reasons above relating to the direct contact between the first pipe layer 14 and the ferrule 28.

The second and third pipe layers 16, 18 may each be made of any suitable material, e.g., one and/or the other, may be a polymeric pipe layer. As such, either of the second and third pipe layers 16, 18 may comprise a polymer, e.g., a thermoplastic polymer. The second pipe layer 16 may provide a cover layer, or an outer protective layer, protecting the pipe 10 from external environmental factors, e.g., UV radiation and mechanical damage. Suitable polymers for the third pipe layer 18 include high-density polyethylene (HDPE), PP, and PEX. In the case of both the second and third pipe layers 16, 18, other polymers are contemplated, and polymer blends may be used. The third pipe layer 18 may provide an impervious liner layer, or an inner barrier layer, providing resistance to a fluid transported through the pipe 10. Suitable polymers for the second pipe layer 16 include HDPE, polyamide (PA), PVDF, polyethylene of raised temperature resistance (PE-RT), PEX, and polyphenylene sulphide (PPS). The third pipe layer 18 may be formed of multiple sub-layers (not shown), e.g., an inner liner layer, a tie layer, and an outer liner layer.

The first, second and third pipe layers 14, 16, 18 may be any suitable thickness, i.e., radial thickness, depending on the service requirements in a given embodiment. In certain embodiments, the first pipe layer 14 may have a thickness of at least 0.039 inches (˜1.00 mm) and/or up to 0.825 inches (˜20.96 mm). Additionally, or alternatively, the second pipe layer 16 may have a thickness of at least 0.079 inches (˜2.00 mm) and/or up to 0.375 inches (˜9.525 mm), and/or the third pipe layer 18 may have a thickness of at least 0.197 inches (˜5.00 mm) and/or up to 0.825 inches (˜20.96 mm).

The pipe 10 may be manufactured by a method according to an embodiment of the invention. The method comprising providing the pipe body 10, providing the end fitting comprising the ferrule 28; removing a length of the second pipe layer 16 at a first end 24 of the pipe body 12 to provide a length 32 of the pipe body free of the second pipe layer 16, and introducing the pipe body 12 into the ferrule 28, i.e., the ferrule 28 over the pipe body 12, so bringing the first pipe layer 14 and the ferrule 28 into direct contact with one another when forming the connection between the pipe body 12 and the end fitting 22. In embodiments comprising the stem 26, the method comprises introducing the pipe body 12 into the annular gap 30. Removing the length of the second pipe layer 16 may be by any suitable means, e.g., by making a circumferential cut through the thickness of second pipe layer 16 and subsequently pulling, or peeling, the second pipe layer 16 away from the first pipe layer 14. The cut may be made with a hot knife.

The method may further comprise removing a length of the third pipe layer 18 at the first end 24 of the pipe body 12 to provide a further length of the pipe body 12 free of the third pipe layer 18. The length of the second pipe layer 16 and the length of the third pipe layer 18 removed from the pipe body 12 may be the same length. The removal of the length of the third pipe layer 18 brings the first pipe layer 14 and the stem 26 into direct contact with one another when forming the connection between the pipe body 12 and the end fitting 22.

The first end 24 of the pipe body 12 may then be clamped in a conventional manner. The ferrule 28 is pressed, e.g., crimped or swaged, to clamp the pipe body 12 against the stem 26 and thereby effect load transfer between the pipe body 12 and the end fitting 22. The clamping may provide a fluid-tight seal between the second pipe layer 16 and the ferrule 28. The the clamping may provide a fluid-tight seal between the third pipe layer 18 and the stem 26.

The invention is not restricted to the details of any foregoing embodiments. In particular, embodiments are contemplated comprising the third pipe layer 18 absent the second pipe layer 16, in which the length of the third pipe layer 18 is removed to contact the stem 26. Such embodiments may comprise the ferrule 28, though certain embodiments the ferrule 28 may be absent. Consequently, in the appended claims, reference to the second and third pipe layers 16, 18 may be used interchangeably. The same applies to the first and second tubular connector members 26, 28. In embodiments comprising further pipe layers, respective lengths of one or more of the further pipe layers may be removed to enable direct contact between the first pipe layer 14 and the end fitting 22. Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, or characteristics described in conjunction with a particular aspect, embodiment or example of the invention are to be understood to be applicable to any other aspect, embodiment or example described herein unless incompatible therewith. In particular, the words “certain embodiments” are to be understood to mean any embodiment described, illustrated, or otherwise disclosed herein, unless expressly stated otherwise. All of the features disclosed in this specification (including any accompanying claims, abstract and drawings), and/or all of the steps of any method or process so disclosed, may be combined in any combination, except combinations where at least some of such features and/or steps are mutually exclusive. The invention extends to any novel one, or any novel combination, of the features disclosed in this specification (including any accompanying claims, abstract and drawings), or to any novel one, or any novel combination, of the steps of any method or process so disclosed.

Attention is directed to all papers and documents which are filed concurrently with or previous to this specification in connection with this application and which are open to public inspection with this specification, and the contents of all such papers and documents are incorporated herein by reference.

1. A flexible pipe comprising:
a pipe body comprising first and second pipe layers, the first pipe layer being a composite pipe layer formed of a composite comprising a reinforcement embedded in a thermoplastic matrix material; and
an end fitting to which a first end of the pipe body is connected, the end fitting comprising a tubular connector member concentric to the pipe body,
wherein a length of the pipe body at the first end is free of the second pipe layer so exposing the first pipe layer to the tubular connector member to enable direct contact therebetween.

2. A flexible pipe according to claim 1, wherein the first pipe layer is disposed radially inward of the second pipe layer and the tubular connector member is disposed radially outward of the first pipe layer.

3. A flexible pipe according to claim 1, wherein the first pipe layer is formed of one or more helically wrapped tapes formed of the composite, and optionally wherein the reinforcement comprises a plurality of metallic wires.

4. A flexible pipe according to claim wherein the second pipe layer is a polymeric pipe layer providing a protective layer.

5. A flexible pipe according to claim 1, wherein the end fitting comprises a further tubular connector member disposed radially inward of the first pipe layer.

6. A flexible pipe according to claim 1, wherein the pipe body comprises a third pipe layer disposed radially inward of the first pipe layer.

7. A flexible pipe layer according to claim 6, wherein the third pipe layer is a polymeric pipe layer providing an impervious liner layer.

8. A flexible pipe layer according to claim 6, wherein the end fitting comprises a further tubular connector member disposed radially inward of the first pipe layer, and
wherein a further length of the pipe body at the first end is free of the third pipe layer so exposing the first pipe layer to the further tubular connector member to enable direct contact therebetween.

9. A flexible pipe layer according to claim 5, wherein the first pipe layer is clamped between the tubular connector member and the further tubular connector member.

10. A flexible pipe layer according to claim 9, wherein the pipe body comprises a third pipe layer disposed radially inward of the first pipe layer, and
wherein the third pipe layer is clamped, together with the first pipe layer, between the tubular connector member and the further tubular connector member.

11. A flexible pipe according to claim 1, wherein the pipe is a reinforced thermoplastic pipe for conveying oil and gas field fluids.

12. A method of manufacturing a flexible pipe, the method comprising:
providing a pipe body comprising first and second pipe layers, the first pipe layer being a composite pipe layer formed of a composite comprising a reinforcement embedded in a thermoplastic matrix material;
providing an end fitting comprising a tubular connector member;
removing a length of the second pipe layer at a first end of the pipe body to provide a length of the pipe body free of the second pipe layer; and
introducing the pipe body into the tubular connector member, or visa versa, so bringing the first pipe layer and the tubular connector member into direct contact with one another.

13. A method according to claim 12, wherein the first pipe layer is disposed radially inward of the second pipe layer, and the method comprises introducing the pipe body into the tubular connector member.

14. A method according to claim 13, wherein the end fitting comprises a further tubular connector member disposed radially inward of the tubular connector member and an annular gap extending therebetween, and the method comprises introducing the pipe body into the annular gap.

15. A method according to claim 14, wherein the wherein the pipe body comprises a third pipe layer disposed radially inward of first pipe layer, the method comprises removing a length of the third pipe layer at the first end of the pipe body to provide a further length of the pipe body free of the third pipe layer, and introducing the pipe body into annular gap so bringing the third pipe layer and the further tubular connector member into direct contact with one another.

16. A method according to claim 14, wherein the method comprises clamping the first end of the pipe body in the annular gap.

17. A method according to any of claim 16, wherein clamping the first end of the pipe body comprises clamping the first pipe layer only.

18. A method according to claim 16, wherein clamping the first end of the pipe body comprises crimping or swagging the tubular connector member.
